(19) United States
(12) Patent Application Publication
(10) Pub. No.: US 2018/0196533 A1
(43) Pub. Date: Jul. 12, 2018

(54) TIP AND STYLUS HAVING THE SAME

(71) Applicant: ADONIT CO., LTD., Taipei (TW)

(72) Inventors: Zachary Joseph ZELIFF, Taipei (TW); Hong Bin KOH, Taipei (TW); Chien-Pang LIN, Taipei (TW); Reinier BLOEM, Taipei (TW)

(21) Appl. No.: 15/748,909

(22) PCT Filed: Aug. 1, 2016
(86) PCT No.: PCT/US16/45036

§ 371 Date: Jan. 30, 2018

Related U.S. Application Data
(60) Provisional application No. 62/198,693, filed on Jul. 30, 2015.

(51) Int. Cl. G06F 3/0354; G06F 3/044

(52) U.S. Cl. CPC G06F 3/03545; G06F 2203/04101; G06F 3/044

(57) ABSTRACT

A tip and stylus for a capacitive sensor are provided. The stylus includes a stylus body, an amplifier circuit, and a tip. The tip includes a first electrode, an insulating element, a second electrode, and a shield. The first electrode has a thread element at a distal end of the first electrode. The second electrode is aligned with a longitudinal axis of the stylus, the longitudinal axis being parallel with a central axis of the stylus. The shield is disposed between the first electrode and the second electrode. The first electrode and the second electrode are electrically insulated from the shield by a cap layer, in which the first electrode, the second electrode, and the shield selectively move in response to the tip of the stylus contacting a touch screen having the capacitive sensor in accordance to an angle of contact and a contact force.

### CROSS REFERENCE TO RELATED APPLICATIONS

This application claims the benefit of priority to U.S. provisional patent application No. 62/198,693, entitled “TIP AND STYLUS HAVING THE SAME” filed on Jul. 30, 2015, the content of which is hereby incorporated by reference in its entirety for all purposes.

### BACKGROUND OF THE INVENTION

### Field of the Invention

The disclosure relates to a tip and a stylus having the same, and more particularly to a stylus having a tip with multi-part electrodes.

### Brief Description of Related Art

Generally speaking, styluses for use with capacitive touchscreens require a minimum level of capacitance between the stylus and the touchscreen for the capacitive sensor in the touchscreen to accurately detect the position of the stylus. Nowadays, most such styluses are passive, having a wide conductive tip that is electrically coupled to the stylus body, such that when the body is gripped by a user, the user is electrically coupled to the tip. This allows the capacitance of the user's body to be sensed by the touchscreen across a large enough area to simulate a fingertip touch. Touchscreens on many of the most popular devices today require such large touches and capacitances in order to function; contacts by smaller capacitances or across smaller contact regions are ignored by the devices' firmware in order to reject capacitive noise, thereby helping to lower complexity and cost.

Precisely locating and “touching” points on a screen is aided by having a stylus with a small, non-deforming tip. Not only does a small tip allow the surrounding screen to be seen by the user, thereby helping the user to position the tip precisely, but also a non-deforming tip means that the firmware will have a consistent contact shape from which to determine the centroid.

Higher resolution touchscreens exist, but generally require a stylus that is specifically designed to interact with the given touchscreen so that the touchscreen can ignore other touches as noise. This eliminates the user's ability to use a fingertip to interact with the touchscreen, drastically reducing convenience and requiring that special hardware (the stylus) be developed and kept with the device.

Touchpad capacitive sensors are designed to require close proximity to avoid accidental touch detection, further limiting their capabilities. For example, custom hardware has been developed by some manufacturers that enable a stylus to be detected at some distance from the screen, thus allowing a touchscreen to display a cursor at an anticipated contact point. But this does not work for standard capacitive touchscreens which are designed to detect the capacitance of a user's fingertip; instead, special hardware for these touchscreens requires the use of a special stylus, thereby entirely preventing users from using their fingertips.

However, fine tip active styluses that interact with a capacitive sensor in a touchscreen are susceptible to an offset problem, and may be too thick and bulky for comfortable use with devices such as smartphones. Therefore, a stylus capable of accurately interacting with a mutual capacitance touch device using a small, non-deformable tip is therefore desirable.

### SUMMARY OF THE INVENTION

In one aspect, embodiments of the invention provide a tip of a stylus for a capacitive sensor. The tip includes a first electrode, an insulating element, a second electrode, and a shield. The first electrode has a thread element at a distal end of the first electrode. The second electrode is aligned with a longitudinal axis of the stylus, the longitudinal axis being parallel with a central axis of the stylus. The shield is disposed between the first electrode and the second electrode. The first electrode and the second electrode are electrically insulated from the shield by a cap layer, in which the first electrode, the second electrode, and the shield selectively move in response to the tip of the stylus contacting a touch screen having the capacitive sensor in accordance to an angle of contact and a contact force.

According to an embodiment of the invention, the tip further includes a ring element disposed on the thread element between the distal end of the first electrode and the insulating element.

According to an embodiment of the invention, the tip further includes a spring element disposed on the shield, wherein the ring element and the spring element provide a restoring force when the stylus contacts the touch screen.

According to an embodiment of the invention, the magnitude of the restoring force is related to the angle of contact and the contact force.

According to an embodiment of the invention, the spring element has an elongated lead at a distal end.

According to an embodiment of the invention, the insulating element disposed on the shield has an inner ridged portion.

According to an embodiment of the invention, the shield has a retaining ring, and the cap layer is disposed on the retaining ring.

According to an embodiment of the invention, a proximal part of the shield and a distal part of the shield are joined in a flared portion of the shield.

According to an embodiment of the invention, the cap layer comprises PET, ETFE, PTFE, HDPE, or nylon.

According to an embodiment of the invention, the cap layer has a thickness of less than or equal to 0.1 mm.

In another aspect of the invention, embodiments of the invention provide a stylus for a capacitive sensor, the stylus including a stylus body, an amplifier circuit, and a tip. The tip includes a first electrode, an insulating element, a second electrode, and a shield. The first electrode has a thread element at a distal end of the first electrode. The second electrode is aligned with a longitudinal axis of the stylus, the longitudinal axis being parallel with a central axis of the stylus. The shield is disposed between the first electrode and the second electrode. The first electrode and the second electrode are electrically insulated from the shield by a cap layer, in which the first electrode, the second electrode, and the shield selectively move in response to the tip of the stylus contacting a touch screen having the capacitive sensor in accordance to an angle of contact and a contact force.

### BRIEF DESCRIPTION OF THE DRAWINGS

FIG. 1A is a perspective view of a stylus and a touchscreen according to an embodiment of the invention.

FIG. 1B is a perspective view of a stylus and a touchscreen in use according to an embodiment of the invention.

FIG. 2 is a perspective view of a stylus tip for a capacitive sensor according to an embodiment of the invention.

FIG. 3 is a front view of a stylus tip for a capacitive sensor according to an embodiment of the invention.

FIG. 4 is a side view of a stylus tip for a capacitive sensor according to an embodiment of the invention.

FIG. 5 is a cross-sectional view of a stylus tip for a capacitive sensor across a line A-A according to an embodiment of the invention.

FIG. 6 is an expanded view of a stylus tip for a capacitive sensor across a line A-A according to an embodiment of the invention.

FIG. 7 is a side view of a stylus tip for a capacitive sensor according to an embodiment of the invention.

FIG. 8 is a cross-sectional view of a stylus tip for a capacitive sensor across a line A-A according to an embodiment of the invention.

FIG. 9 is an expanded view of a stylus tip for a capacitive sensor across a line A-A according to an embodiment of the invention.

### DETAILED DESCRIPTION OF THE PREFERRED EMBODIMENTS

The following detailed description of embodiments references the accompanying drawings that form a part hereof, in which are shown various illustrative embodiments through which the invention may be practiced. In the drawings, like reference numbers indicate like features or functionally identical steps. The embodiments are described in sufficient detail to enable those skilled in the art to practice the invention, and it is to be understood that other embodiments may be utilized and that logical changes may be made without departing from the spirit and scope of the invention. The detailed description is therefore not to be taken in a limiting sense, and the scope of the invention is defined solely by the appended claims.

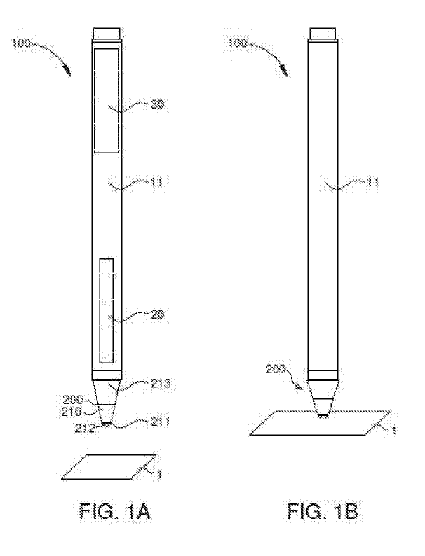

Please refer to FIG. 1, which is a perspective view of a stylus 100 and a touchscreen 1 according to an embodiment of the invention. In the present embodiment, the stylus 100 includes a tip 10, a body 11, a fairing 12, an emitting electrode 110, a sensing electrode 112, and a shield 111. A printed circuit board (PCB) 20 and a battery 30 depicted as dashed outlines may be housed inside the body 11. The body 11 may be attached into the fairing 12 of the stylus 100. In the present embodiment, the printed circuit board 20 may include all circuitry necessary to implement the various electronic functions of the stylus 100, including a battery charging circuit, an amplifier circuit, and a power source circuit coupled to the amplifier circuit, a communication module for communicating with the touchscreen 1, a power switch, and so forth, although the invention is not limited thereto.

Moreover, an input terminal of the amplifier circuit may be electrically coupled to the sensing electrode 112 of the tip, and an output terminal of the circuit may be electrically coupled to the emitting electrode 110 of the tip. The amplifier circuit may receive a signal through the sensing electrode, amplify and inverts the signal, and output the signal through the emitting electrode 110 to the touchscreen 1. Furthermore, the amplifier circuit may amplify only a portion of the signal that exceeds a threshold voltage. For example, the amplifier circuit may modify amplification of the signal according to information received from the device through the communication module in the printed circuit board 20.

In a passive capacitive stylus, the stylus body may serve to electrically couple a conductive tip to the user's hand. On the other hand, an active stylus does not necessarily need to use the stylus body to couple the conductive tip to the hand, and therefore the active stylus may be made of either conductive or nonconductive materials, or a combination thereof. In the present embodiment, the body 11 of the stylus 100 may serve to hold the tip 10 and to contain active electronic circuitry 20 and the battery 30 for powering the active electronic circuitry 20. In FIG. 1, the tip 10 may be an anodized sensor/emitter tip, for example, although the invention is not limited thereto. The shield 111 may separate the emitting electrode 110 and the sensing electrode 112. The touchscreen 1 may be any type of touchscreen containing a sensor capable of sensing a mutual capacitance between the stylus 100 and the touchscreen 1. For example, the touchscreen 1 may include a capacitive sensor having a plurality of driving lines and a plurality of sensing lines (not shown) for sensing the mutual capacitance the stylus 100 and the touchscreen 1.

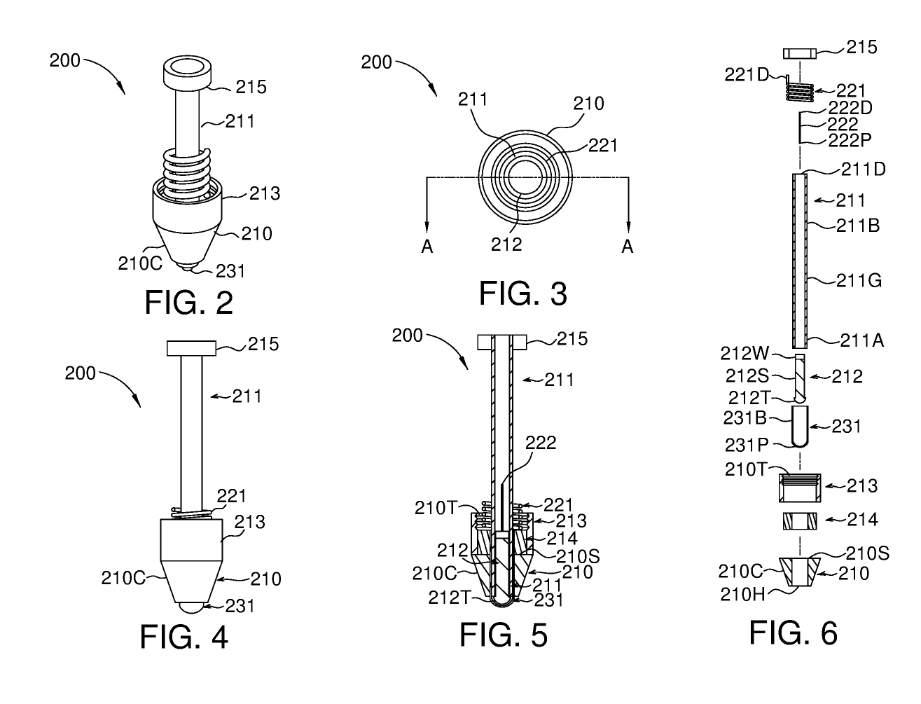

With reference to FIG. 2 to FIG. 6, these drawings illustrate five (perspective, front, side, cross-sectional, and expanded, respectively) of an embodiment of a stylus tip for a capacitive sensor. In the present embodiment, a tip 200 has an emitting electrode 210, a shield 211, and a sensing electrode 212. The emitting electrode 210 has a thread element 210T and a shoulder 210S at a distal end so that an insulating element 213 may be screwed onto a stylus body (e.g. the body 11 in FIG. 1) with the shoulder 210S abutting a front end edge of the insulating element 213. The insulating element 213 disposed on the shield 211 may also have an inner ridged portion as depicted in FIG. 5 and FIG. 6. The shield 211 may be disposed between the emitting electrode 210 and the sensing electrode 212. In the present embodiment, the sensing electrode 212 may be aligned with a longitudinal axis of a stylus, in which the longitudinal axis being parallel with a central axis of the stylus. The emitting electrode 210 may have an ogive shaped outer surface 210C to increase the diameter of the electrode nearer the contact with a touchscreen surface, thereby increasing capacitance between the outer surface 210C and a touchscreen surface as the stylus with the tip 200 is brought near the touchscreen surface. Accordingly, the tip 200 may allow for a reduction in the voltage used by the stylus, and hence reducing the overall power needs of the active stylus 10. The emitting electrode 210 may further have a central hole 210H through which the shield 211, which contains and isolates the sensing electrode 212, protrudes. The shield 211 in the present embodiment does not have a flange; its diameter is about the same as the diameter of the sensing electrode tip 212T's widest diameter.

The shield 211 may be made of a conductive material or materials such as a metal or a conductive polymer, and may be monolithic or made of a plurality of different materials, although the invention is not limited thereto. The shield 211 may be of sufficiently smaller diameter than a central hole 210H of the emitting electrode 210 to allow a cap layer 231 to be placed over the shield 211 and sensing electrode 212. The cap layer 231 may serve as a low-friction bearing between the shield 211 and the emitting electrode 210, and the cap layer 231 may protect the touchscreen 1 from the tip 212T of the sensing electrode 212. The cap layer 231 may be a polymer made of PET, ETFE, PTFE, HDPE, nylon, or another low-friction long-wearing non-conducting polymer, for example, although the invention is not limited thereto. The cap layer 231 may also be designed to be user-replaceable as it wears out either at its proximal face 231P or along its sides on its bearing surface 231S. The shield 211 may optionally further comprise a retaining ring 211G (shown in FIG. 6) that the cap layer 231 can disposed on (e.g. slipped over) in order to prevent the cap layer 231 from sliding off. The shield 211 has a proximal conduit 211A and a distal conduit 211B with their centers aligned with its longitudinal axis, into which the sensing electrode 212 fits. The proximal end of the spring 221 may rest in a well 212W formed in the back of the sensing electrode 212.

The sensing electrode 212, which includes the sensing electrode shaft 212S and sensing electrode tip 212T, may be disposed within the shield 211 and may be electrically coupled to the PCB (e.g. PCB 20 of FIG. 1) by a wire 222 inside the shield 211, which may also serve to bias the assembly of the sensing electrode 212 and the shield 211 outward from the stylus (e.g. stylus 100 of FIG. 1). Furthermore, a ring element 214 may be disposed on the thread element 210T between the distal end of the emitting electrode 210 and the insulating element 213. In addition, the tip 200 in the present embodiment may include a spring element 221 disposed on the shield 211, in which the ring element 214 and the spring element 221 provide a restoring force when the stylus 100 contacts the touch screen 1. The spring 221 may have an elongated lead at a distal end 221D, which may be electrically coupled to a printed circuit board (e.g. PCB 20). The sensing electrode tip 212T may be in the shape of a hemisphere or spherical cap or other smoothly curved surface, and may optionally be wider than the sensing electrode shaft 212S. Accordingly, the emitting electrode 210, the sensing electrode 212, and the shield 211 may selectively move in response to the tip 200 of the stylus contacting the touch screen 1 having the capacitive sensor in accordance to an angle of contact and a contact force. It should be noted that the magnitude of the restoring force provided by the ring element 214 and the spring element 221 may be related to the angle of contact and the contact force.

In use, the sensing electrode 212, shield 211, and emitting electrode 210 may be electrically coupled to their respective contact pads on a PCB 20 having an inverting amplifier circuit (not shown).

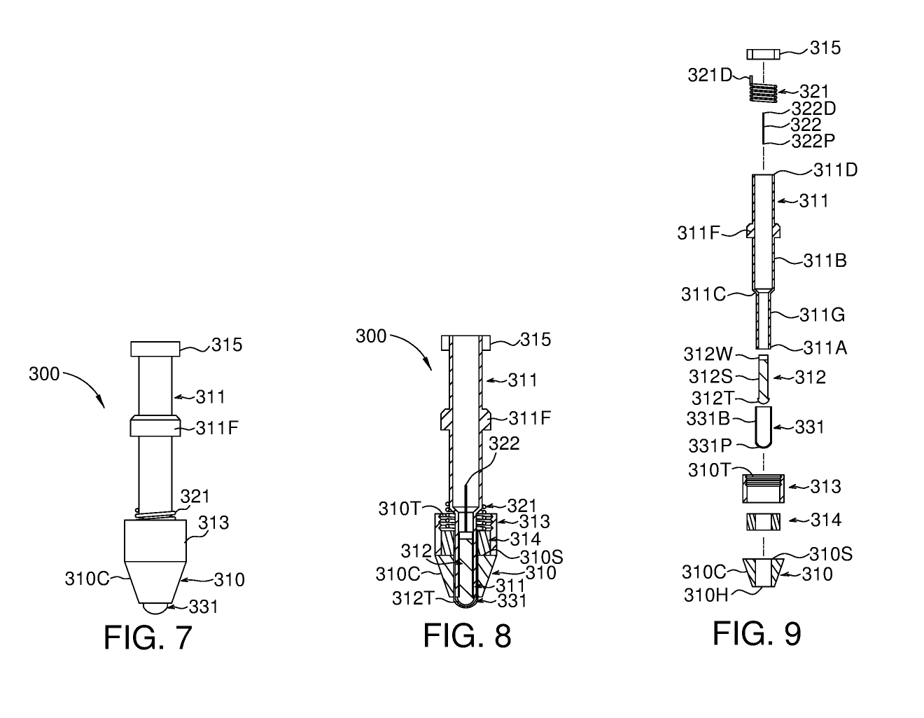

It should be appreciated that the tip 200 depicted in FIGS. 2-6 may have alternative configurations so to facilitate a narrower profile or to include other features (e.g. force sensing). With reference to FIG. 7 to FIG. 9, these drawings illustrate the side, cross-sectional, and expanded views of another embodiment of a stylus tip for a capacitive sensor. In the present embodiment, a tip 300 has an emitting electrode 310, a shield 311, and a sensing electrode 312. One difference between the tip 300 of FIG. 7 to FIG. 9 and the tip 200 of FIG. 2 to FIG. 6 is that, the shield 311 of the tip 300 has a proximal conduit 311 and a distal conduit 311B that are joined in a flared portion 311F of the shield 311.

The emitting electrode 310 has a thread element 310T and a shoulder 310S at a distal end so that an insulating element 313 may be screwed onto a stylus body (e.g. the body 11 in FIG. 1) with the shoulder 310S abutting a front end edge of the insulating element 313. The insulating element 313 disposed on the shield 311 may also have an inner ridged portion as depicted in FIG. 8 and FIG. 9. The shield 311 may be disposed between the emitting electrode 310 and the sensing electrode 312. In the present embodiment, the sensing electrode 312 may be aligned with a longitudinal axis of a stylus, in which the longitudinal axis being parallel with a central axis of the stylus. The emitting electrode 310 may have an ogive shaped outer surface 310C to increase the diameter of the electrode nearer the contact with a touchscreen surface, thereby increasing capacitance between the outer surface 310C and a touchscreen surface as the stylus with the tip 300 is brought near the touchscreen surface. Accordingly, the tip 300 may also allow for a reduction in the voltage used by the stylus, and hence reducing the overall power needs of the active stylus 10. The emitting electrode 310 may further have a central hole 310H through which the shield 311, which contains and isolates the sensing electrode 312, protrudes. The shield 311 in the present embodiment include the flared portion 311F which interacts with travel-limiting blocks (not shown) inside the chassis 11 of a stylus 10 to prevent overtravel in both forward (less force) and rearward (excessive force) directions. This allows the shield 311 to have a narrow tip, desirable for usability reasons, while also accommodating the PCB (e.g. PCB 20), which cannot be made too narrow without sacrificing strength.

The sensing electrode 312, which includes the sensing electrode shaft 312S and sensing electrode tip 312T, may be disposed within the shield 311 and may be electrically coupled to the PCB (e.g. PCB 20 of FIG. 1) by a wire 322 inside the shield 311, which may also serve to bias the assembly of the sensing electrode 312 and the shield 311 outward from the stylus (e.g. stylus 100 of FIG. 1). Furthermore, a ring element 314 may be disposed on the thread element 310T between the distal end of the emitting electrode 310 and the insulating element 313. In addition, the tip 300 in the present embodiment may include a spring element 321 disposed on the shield 311, in which the ring element 314 and the spring element 321 provide a restoring force when the stylus 100 contacts the touch screen 1. The spring 321 may have an elongated lead at a distal end 321D. The sensing electrode tip 312T may be in the shape of a hemisphere or spherical cap or other smoothly curved surface, and may optionally be wider than the sensing electrode shaft 312S. Accordingly, the emitting electrode 310, the sensing electrode 312, and the shield 311 may selectively move in response to the tip 300 of the stylus contacting the touch screen 1 having the capacitive sensor in accordance to an angle of contact and a contact force. It should be noted that the magnitude of the restoring force provided by the ring element 314 and the spring element 321 may be related to the angle of contact and the contact force.

In use, the sensing electrode 312, shield 311, and emitting electrode 310 may be electrically coupled to their respective contact pads on the PCB 20 having an inverting amplifier circuit (not shown).

It should be noted that, the spring 321 may also be configured inside the shield 311 so as to implement a force sensing feature, for example. The distal end 321D of the spring 321 may be soldered to the PCB 20 of FIG. 1, while the proximal end of the spring 321 rests in a well 312W formed in the back of the sensing electrode 312. The shield 311 may then be mechanically coupled to a force sensor (not shown) such as a gated photodetector and light source, or a diaphragm with one or more strain gauges, or a spring and sensor to detect longitudinal depression of the sensing electrode and shield assembly.

In some embodiments, the shield 311 may be formed of anodized aluminum and has a copper ring 315 press-fit around its distal end 311D to provide a place to form a reliable solder joint with a wire (not shown) while ensuring conductivity to the aluminum portion of the shield 311. In said embodiments, anodizing and surface oxidation of the shield 211 must be removed from the outside surface of the distal end 311D prior to installation of the copper ring 315 in order to ensure maximum conductivity. The anodization may be retained elsewhere on the shield 311 to provide insulation between the shield 311 and the sensing electrode 312, and between the shield 311 and the emitting electrode 310. Moreover, the shield 311 may be a slip fit within a central hole 310H of the emitting electrode 310. The shield 311 may be made of a conductive material or materials such as a metal or a conductive polymer, and may be monolithic or made of a plurality of different materials, although the invention is not limited thereto. The shield 311 may also be of sufficiently smaller diameter than the central hole 310H of the emitting electrode 310 to allow a cap layer 331 to be placed over the shield 311 and sensing electrode 312. The cap layer 331 may serve a low-friction bearing between the shield 311 and the emitting electrode 310, and the cap layer 331 may protect the touchscreen 1 from the tip 312T of the sensing electrode 312. The cap layer 331 may be a polymer made of PET, ETFE, PTFE, HDPE, nylon, or another low-friction long-wearing non-conducting polymer, for example, although the invention is not limited thereto. The cap layer 331 may also be designed to be user-replaceable as it wears out either at its proximal face 331P or along its sides on its bearing surface 331S. The shield 311 may optionally further include a retaining ring 311G (shown in FIG. 9) that the cap layer 331 can disposed on (e.g. slipped over) in order to prevent the cap layer 331 from sliding off. The thickness of the cap layer 331 may be less than or equal to 0.1 mm, although other dimensions are also possible according to the applications or features needed, such as further sound dampening when the tip 200 contacts the touch screen 1. The shield 311 has the proximal conduit 311B and the distal conduit 311B through its center aligned with its longitudinal axis, into which the sensing electrode 312 fits.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A tip of a stylus for a capacitive sensor, the tip comprising:
a first electrode having an insulating element and a shoulder at a distal end of the first electrode, wherein a thread element is disposed on the insulating element;
a second electrode aligned with a longitudinal axis of the stylus, the longitudinal axis being parallel with a central axis of the stylus, the second electrode having a sensing electrode shaft and a sensing electrode tip radially protruded from one end of the sensing electrode shaft;
a shield disposed between the first electrode and the second electrode, the insulating element being abutted upon the shoulder of the first electrode, wherein the sensing electrode shaft is inserted in the shield and the sensing electrode tip is engaged with one end edge of the shield, the first electrode and the second electrode are electrically insulated from the shield by a cap layer;
a ring element being accommodated in the insulating element;
a spring element being accommodated in the insulating element and contacted against the ring element, wherein the ring element and the spring element surround on the shield;
wherein the first electrode, the second electrode, and the shield selectively move in response to the tip of the stylus when contacting a touch screen having the capacitive sensor in accordance to an angle of contact and a contact force, the ring element and the spring element provide the restoring force when the stylus contacts the touch screen.

2. The tip according to claim 1, the ring element being disposed on the thread element between the distal end of the first electrode and the insulating element.

3. The tip according to claim 1, the diameter of the shield being similar to the diameter of the sensing electrode tip's widest diameter.

4. The tip according to claim 1, wherein the magnitude of the restoring force is related to the angle of contact and the contact force.

5. The tip according to claim 1, wherein the spring element has an elongated lead at a distal end.

6. The tip according to claim 1, wherein the insulating element disposed on the shield has an inner ridged portion.

7. The tip according to claim 1, wherein the shield has a retaining ring, and the cap layer is disposed on the retaining ring.

8. The tip according to claim 1, wherein a proximal part of the shield and a distal part of the shield are joined in a flared portion of the shield.

9. The tip according to claim 1, wherein the cap layer comprises PET, ETFE, PTFE, HDPE, or nylon.

10. The tip according to claim 1, wherein the cap layer has a thickness of less than or equal to 0.1 mm.

11. A stylus for a capacitive sensor, the stylus comprising:
a stylus body;
an amplifier circuit;
a tip, comprising:
a first electrode having an insulating element and a shoulder at a distal end of the first electrode, wherein a thread element is disposed on the insulating element;
a second electrode aligned with a longitudinal axis of the stylus, the longitudinal axis being parallel with a central axis of the stylus, the second electrode having a sensing electrode shaft and a sensing electrode tip radially protruded from one end of the sensing electrode shaft;
a shield disposed between the first electrode and the second electrode, the insulating element being abutted upon the shoulder of the first electrode, wherein the sensing electrode shaft is inserted in the shield and the sensing electrode tip is engaged with one end edge of the shield, the first electrode and the second electrode are electrically insulated from the shield by a cap layer,
a ring element being accommodated in the insulating element;
a spring element being accommodated in the insulating element and contacted against the ring element, wherein the ring element and the spring element surround on the shield;
wherein the first electrode, the second electrode, and the shield selectively move in response to the tip of the stylus when contacting a touch screen having the capacitive sensor in accordance to an angle of contact and a contact force, the ring element and the spring element provide the restoring force when the stylus contacts the touch screen.

12. The stylus according to claim 11, the ring element being disposed on the thread element between the distal end of the first electrode and the insulating element.

13. The stylus according to claim 11, the diameter of the shield being similar to the diameter of the sensing electrode tip's widest diameter.

14. The stylus according to claim 11, wherein the magnitude of the restoring force is related to the angle of contact and the contact force.

15. The stylus according to claim 11, wherein the spring element has an elongated lead at a distal end.

16. The stylus according to claim 11, wherein the insulating element disposed on the shield has an inner ridged portion.

17. The stylus according to claim 11, wherein the shield has a retaining ring, and the cap layer is disposed on the retaining ring.

18. The stylus according to claim 1, wherein a proximal part of the shield and a distal part of the shield are joined in a flared portion of the shield.

19. The stylus according to claim 11, wherein the cap layer comprises PET, ETFE, PTFE, HDPE, or nylon.

20. The stylus according to claim 11, wherein the cap layer has a thickness of less than or equal to 0.1 mm.
